(19) United States
(12) Patent Application Publication
(10) Pub. No.: US 2026/0233834 A1
(43) Pub. Date: Aug. 13, 2026

(54) Control Method for Aerial Vehicle

(71) Applicant: University of Washington, Seattle, WA (US)

(72) Inventors: Sawyer B. Fuller, Seattle, WA (US); Yogesh Madhavrao Chukewad, Seattle, WA (US); Daksh Dhingra, Seattle, WA (US)

(21) Appl. No.: 18/170,094

(22) Filed: Feb. 16, 2023

Related U.S. Application Data
(60) Provisional application No. 63/311,527, filed on Feb. 18, 2022.

(51) Int. Cl. B64C 33/02

(52) U.S. Cl. CPC B64C 33/02

(57) ABSTRACT

A method includes providing a signal to an aerial vehicle, the signal including a first component having a first oscillation frequency and a second component having a second oscillation frequency, and flapping, in response to the signal, a wing of the vehicle, thereby causing the vehicle to rotate. Another method includes providing a first component of a signal to an aerial vehicle during a first time period, the first component having a first oscillation frequency, providing a second component of the signal to the vehicle during a second time period that follows the first time period, the second component having a second oscillation frequency, a first ratio of the first oscillation frequency to the second oscillation frequency being equal to a second ratio of the second time period to the first time period, and flapping, in response to receiving the signal, a wing of the vehicle, thereby moving the vehicle.

### CROSS REFERENCE TO RELATED APPLICATION

The present application is a non-provisional application claiming priority to U.S. provisional application No. 63/311,527, filed on Feb. 18, 2022, the contents of which are hereby incorporated by reference.

### STATEMENT REGARDING FEDERALLY SPONSORED RESEARCH OR DEVELOPMENT

This invention was made with government support under Grant No. FA9550-14-1-0398, awarded by the Air Force Office of Scientific Research. The government has certain rights in the invention.

### BACKGROUND

Aerial vehicles with simple, spring-like flexure wing hinges have demonstrated some roll, pitch, and position control capabilities while hovering, but have not yet been able to demonstrate yaw (e.g, heading) control or actuate themselves in a purely lateral direction without first inclining their body. Such an aerial vehicle generally moves in directions transverse to the yaw axis indirectly by tilting itself so that its thrust vector has a component parallel to the direction of desired motion.

### SUMMARY

A first example includes a method comprising: providing a control signal to an actuator of an aerial vehicle, wherein the control signal comprises a first component having a first oscillation frequency and a second component having a second oscillation frequency that is greater than the first oscillation frequency and is an integer multiple of the first oscillation frequency; and flapping, via the actuator in response to receiving the control signal, a wing of the aerial vehicle, thereby causing the aerial vehicle to rotate about a yaw axis of the aerial vehicle.

A second example includes a non-transitory computer readable medium storing instructions that, when executed by one or more processors, cause an aerial vehicle to perform functions comprising: providing a control signal to an actuator of the aerial vehicle, wherein the control signal comprises a first component having a first oscillation frequency and a second component having a second oscillation frequency that is greater than the first oscillation frequency and is an integer multiple of the first oscillation frequency; and flapping, via the actuator in response to receiving the control signal, a wing of the aerial vehicle, thereby causing the aerial vehicle to rotate about a yaw axis of the aerial vehicle.

A third example includes an aerial vehicle comprising an actuator; a wing; one or more processors; and a computer readable medium storing instructions that, when executed by the one or more processors, cause the aerial vehicle to perform functions comprising: providing a control signal to the actuator, wherein the control signal comprises a first component having a first oscillation frequency and a second component having a second oscillation frequency that is greater than the first oscillation frequency and is an integer multiple of the first oscillation frequency; and flapping, via the actuator in response to receiving the control signal, the wing, thereby causing the aerial vehicle to rotate about a yaw axis of the aerial vehicle.

A fourth example includes a method comprising providing a first component of a control signal to an actuator of an aerial vehicle during a first time period, the first component having a first oscillation frequency; providing a second component of the control signal to the actuator during a second time period that follows the first time period, the second component having a second oscillation frequency, wherein a first ratio of the first oscillation frequency to the second oscillation frequency is equal to a second ratio of the second time period to the first time period; and flapping, via the actuator in response to receiving the control signal, a wing of the aerial vehicle, thereby causing the aerial vehicle to move in a direction transverse to a yaw axis of the aerial vehicle.

A fifth example includes a non-transitory computer readable medium storing instructions that, when executed by one or more processors, cause an aerial vehicle to perform functions comprising: providing a first component of a control signal to an actuator of the aerial vehicle during a first time period, the first component having a first oscillation frequency; providing a second component of the control signal to the actuator during a second time period that follows the first time period, the second component having a second oscillation frequency, wherein a first ratio of the first oscillation frequency to the second oscillation frequency is equal to a second ratio of the second time period to the first time period; and flapping, via the actuator in response to receiving the control signal, a wing of the aerial vehicle, thereby causing the aerial vehicle to move in a direction transverse to a yaw axis of the aerial vehicle.

A sixth example includes an aerial vehicle comprising an actuator; a wing; one or more processors; and a computer readable medium storing instructions that, when executed by the one or more processors, cause the aerial vehicle to perform functions comprising: providing a first component of a control signal to the actuator during a first time period, the first component having a first oscillation frequency; providing a second component of the control signal to the actuator during a second time period that follows the first time period, the second component having a second oscillation frequency, wherein a first ratio of the first oscillation frequency to the second oscillation frequency is equal to a second ratio of the second time period to the first time period; and flapping, via the actuator in response to receiving the control signal, the wing, thereby causing the aerial vehicle to move in a direction transverse to a yaw axis of the aerial vehicle.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of an aerial vehicle, according to an example.

FIG. 2 is a schematic diagram of an aerial vehicle, according to an example.

FIG. 3 is a schematic diagram of a wing and an actuator of an aerial vehicle, according to an example.

FIG. 4 shows control signals and components of control signals, according to an example.

FIG. 5 shows an equation defining angular position of a wing over time, according to an example.

FIG. 6A shows angular positions of a wing over time corresponding to different control signals, according to an example.

FIG. 6B shows torques and forces applied to an aerial vehicle based on various control signals, according to an example.

FIG. 6C shows torques and forces applied to an aerial vehicle based on various control signals, according to an example.

FIG. 6D shows torques and forces applied to an aerial vehicle based on various control signals, according to an example.

FIG. 7 shows equations defining a control signal, according to an example.

FIG. 8A shows control signals and components of control signals, according to an example.

FIG. 8B shows control signals and components of control signals, according to an example.

FIG. 9 is a block diagram of a method, according to an example.

FIG. 10 is a block diagram of a method, according to an example.

FIG. 11A shows an equation defining drag force, according to an example.

FIG. 11B shows a magnitude of a lateral force generated corresponding to varying frequencies and time periods of a control signal, according to an experimental example.

FIG. 12A shows a position of an aerial vehicle along an axis over time, according to an experimental example.

FIG. 12B shows a position of an aerial vehicle along an axis over time, according to an experimental example.

FIG. 12C shows a position of an aerial vehicle along an axis over time, according to an experimental example.

FIG. 12D shows a magnitude of a lateral force applied to an aerial vehicle over time, according to an experimental example.

### DETAILED DESCRIPTION

As discussed above, a need exists for improved methods for lateral control and yaw control of aerial vehicles with simple, spring-like flexure wing hinges. The present disclosure includes such methods for controlling such aerial vehicles.

For example, a signal generator provides a control signal to an actuator of an aerial vehicle. The control signal includes a first component having a first oscillation frequency (e.g., f) and a second component having a second oscillation frequency (e.g., 2 f) that is greater than the first oscillation frequency and is an integer multiple of the first oscillation frequency. The actuator flaps a wing of the aerial vehicle in response to receiving the control signal, thereby causing the aerial vehicle to rotate about a yaw axis of the aerial vehicle. More particularly, the control signal causes the wing to flap faster in the forward direction when compared to the backward direction (or vice versa), which creates differential drag on the wing and a net yaw torque on the aerial vehicle.

In another example, the signal generator provides a first component of a control signal to an actuator of an aerial vehicle during a first time period, the first component having a first oscillation frequency. The signal generator also provides a second component of the control signal to the actuator during a second time period that follows the first time period, the second component having a second oscillation frequency. A first ratio of the first oscillation frequency to the second oscillation frequency is equal to a second ratio of the second time period to the first time period. The actuator flaps a wing of the aerial vehicle in response to receiving the control signal, thereby causing the aerial vehicle to move in a direction transverse to a yaw axis of the aerial vehicle (e.g., without the aerial vehicle tilting about the roll axis or the pitch axis). For example, the asymmetric nature of the control signal and resultant wing flapping causes the aerial vehicle to move along a roll axis of the aerial vehicle, that is, in the forward or reverse direction.

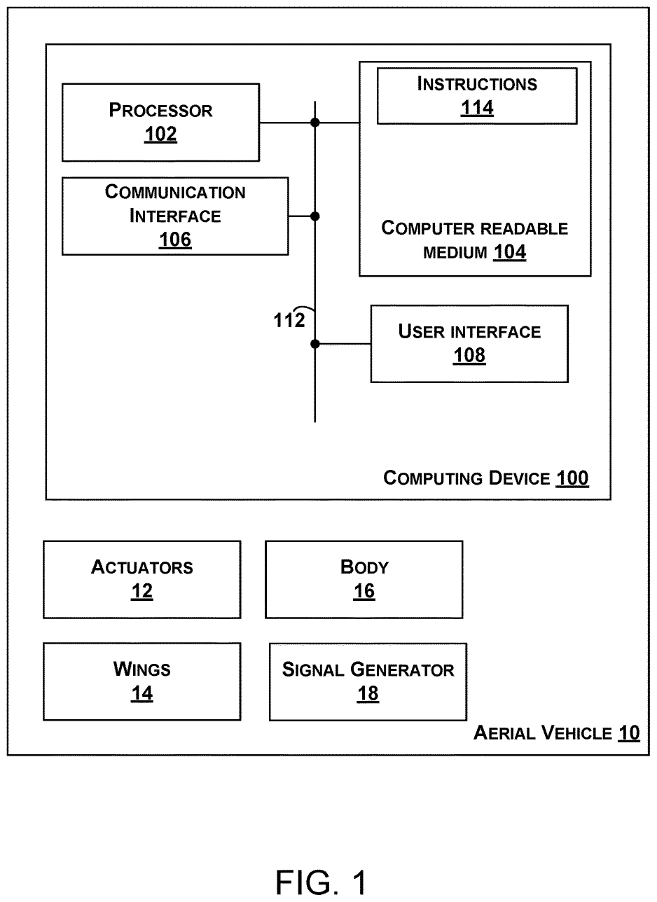

FIG. 1 is a block diagram of an aerial vehicle 10. The aerial vehicle 10 includes actuators 12, wings 14, a body 16, a signal generator 18, and a computing device 100. The actuators 12 generally take the form of piezoelectric actuators, but other examples are possible. The wings 14 are generally made of flexible lightweight materials and are coupled to the actuators 12 with spring-like passive rotational wing hinges. The signal generator 18 can take the form of any circuit that is configured to generate periodic (e.g., sinusoidal) signals having specified oscillation frequencies, waveform shapes, and amplitudes etc.

The computing device 100 includes one or more processors 102, a non-transitory computer readable medium 104, a communication interface 106, and a user interface 108. Components of the computing device 100 are linked together by a system bus, network, or other connection mechanism 112.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 114. The instructions 114 are executable by the one or more processors 102 to cause the computing device 100 to perform any of the functions or methods described herein.

The communication interface 106 can include hardware to enable communication within the computing device 100 and/or between the computing device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices. The communication interface 106 can also include analog-to-digital converters (ADCs) or digital-to-analog converters (DACs) that the computing device 100 can use to control various components of the computing device 100 or external devices.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the computing device 100. For instance, the user interface 108 can include a mouse or a pointing device, a keyboard or a keypad, a microphone, a touchpad, or a touchscreen, among other possible types of user input devices. Generally, the user interface 108 can enable an operator to interact with a graphical user interface (GUI) provided by the computing device 100 (e.g., displayed by the user interface 108).

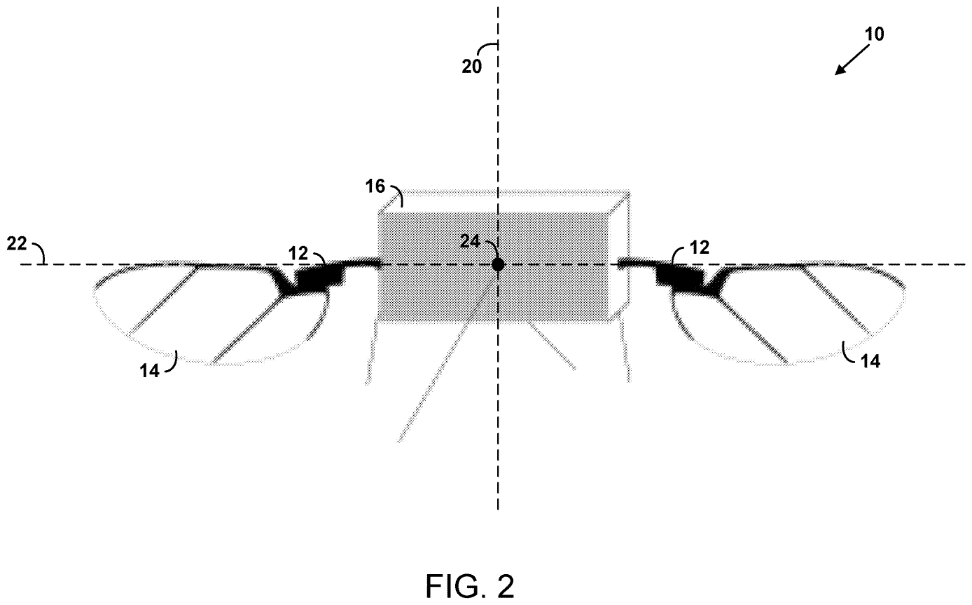

FIG. 2 is a schematic diagram of the aerial vehicle 10. As shown, the wings 14 are attached to the body 16 via the actuators 12. Also shown are a yaw axis 20, a pitch axis 22, and a roll axis 24 that is normal to a plane formed by the yaw axis 20 and the pitch axis 22.

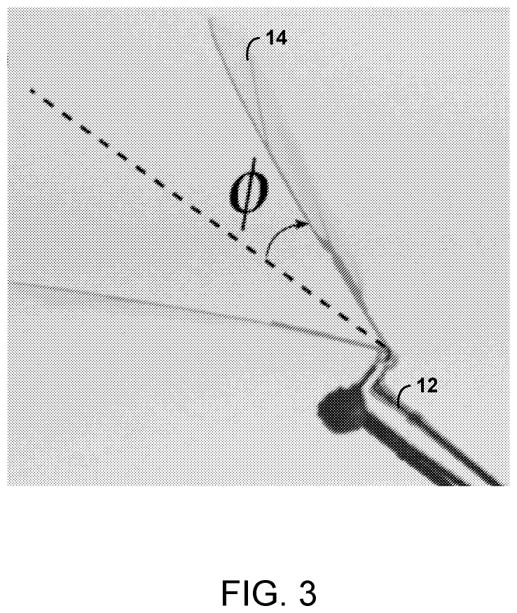

FIG. 3 is a schematic diagram of a wing 14 of the aerial vehicle 10. As shown, the wings 14 are configured to flap back and forth in response to forces applied by respective actuators 12. Such forces are applied by the actuators 12 within a plane that is normal to the yaw axis 20 (e.g., a plane formed by the pitch axis 22 and the roll axis 24).

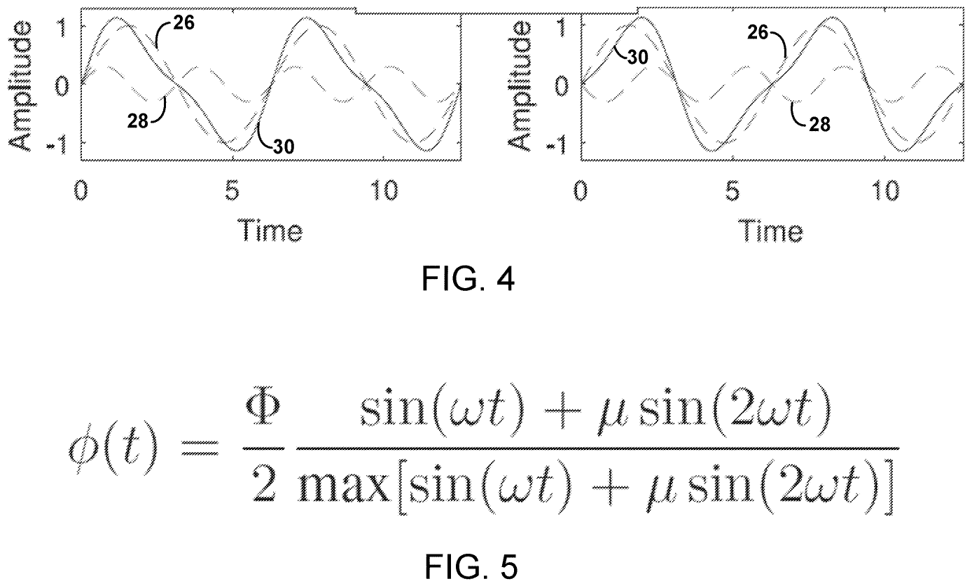

FIG. 4 shows example control signals 30 provided to one or more actuators 12 of the aerial vehicle 10. More particularly, the left and right panels of FIG. 4 each show the signal generator 18 or perhaps a wireless remote control providing a control signal 30 to an actuator 12 of the aerial vehicle 10. In some examples, the control signal 30 is provided to one or more actuators 12 while the aerial vehicle 10 is already hovering.

The control signal 30 includes a component 26 having an oscillation frequency f₁ (e.g., 190 Hz) and a component 28 having an oscillation frequency f₂ (e.g., 380 Hz) that is greater than the oscillation frequency f₁ and is an integer multiple of the oscillation frequency f₁. That is, f₂=nf₁ where n is an integer that is greater than or equal to 2. The control signal 30 represents a superposition (e.g., a sum) of the component 26 and the component 28. The signal generator 18 or the wireless remote control provides the control signal 30 to the actuator 12 and the actuator 12 uses piezoelectricity to vibrate as indicated by the control signal 30. The vibrations of the actuator 12 in turn cause the wing 14 to flap in accordance with the control signal 30.

In some examples, an amplitude of the component 28 is 30% or less of an amplitude of the component 26 and the component 28 is out of phase with the component 26 by 45 to 90 degrees. The component 26 and the component 28 are generally sinusoidal, but other examples are possible.

The control signal 30 can also include one or more additional components, for example, a component having an oscillation frequency f₃ that is an integer multiple of the oscillation frequency f₁ and is greater than the oscillation frequency f₂. The component having the oscillation frequency f₃ is generally out of phase with the component 26 and/or the component 28.

In many examples, the control signal 30 is provided to actuators 12 on opposite sides of the body 16 with a phase difference of 180 degrees. As such, wings 14 on opposite sides of the body 16 flap in response to respective actuators 12 receiving the control signal 30. More particularly, the actuators 12 receiving the control signal 30 causes a wing 14 on a first side of the body 16 to apply a first torque about the yaw axis 20 and a wing 14 on the opposite side of the body 16 to apply a second torque about the yaw axis 20 that is 180 degrees out of phase with the first torque but in the same direction. Generally, flapping the wings 14 provides a thrust parallel to the yaw axis 20 in addition to the torque about the yaw axis 20.

FIG. 5 is an equation that defines an angular position Φ of the wing 14 with respect to time. FIG. 3 shows how the angular position Φ is defined. The angular position Φ varies due to the wing 14 flapping in response to the control signal 30 being provided to the actuator 12. In FIG. 5, ω is the wing angular velocity in rad/s, Φ (in bold) is the peak-to-peak wing amplitude, and μ is the peak-to-peak amplitude of the component 28 relative to the component 26.

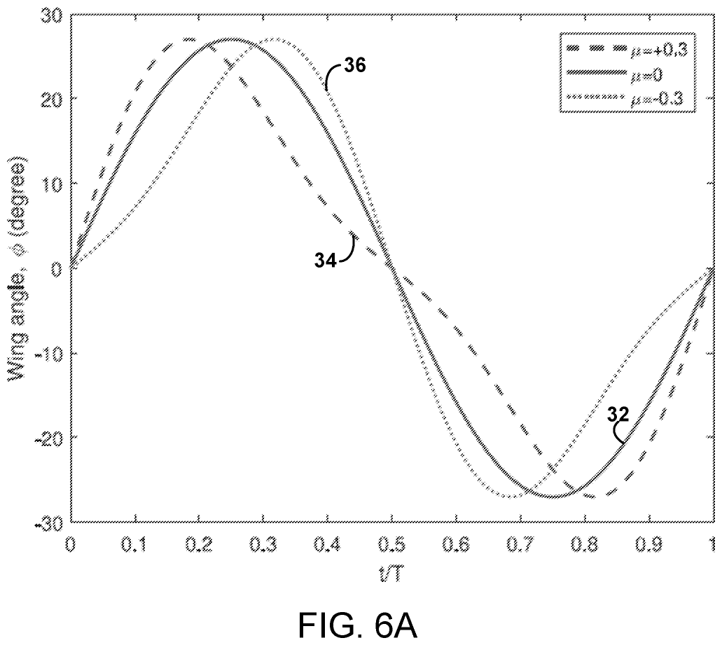

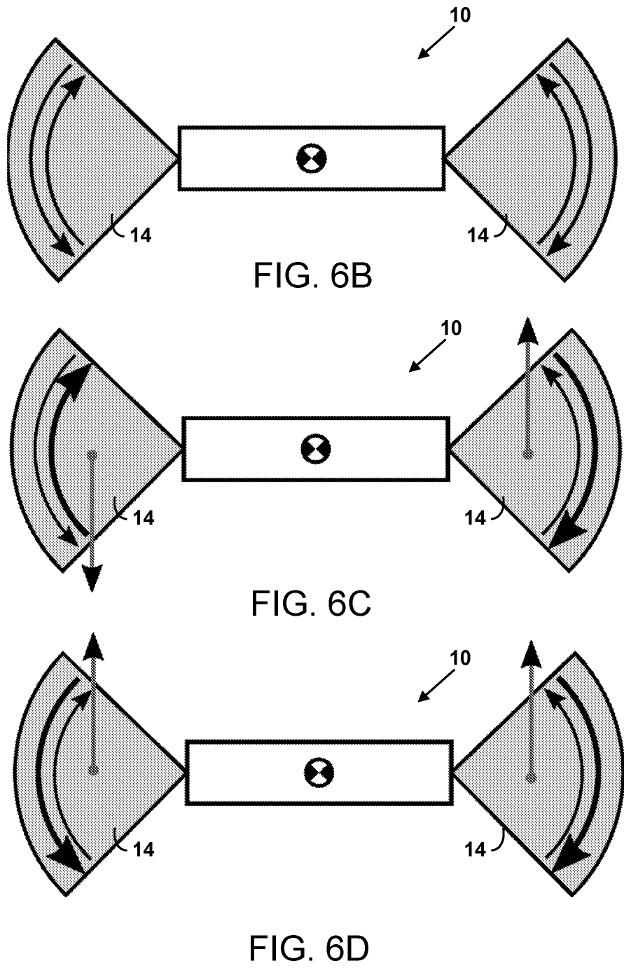

FIG. 6A shows angular position Φ curves corresponding to different values of μ. When μ=0 and the component 28 is not included as part of the control signal 30 at all, the corresponding curve 32 is symmetric and no net torque is provided about the yaw axis 20 by the wings 14. When μ=0.3, the corresponding curve 34 shows that the wing 14 flaps faster in the direction of increasing Φ compared to the direction of decreasing Φ. When μ=−0.3, the corresponding curve 36 shows that the wing 14 flaps faster in the direction of decreasing Φ compared to the direction of increasing Φ.

Thus, when the component 28 is included as part of the control signal 30, the wing 14 periodically flaps in a first rotational direction about the yaw axis 20 over a first time period and then flaps in a second rotational direction that is opposite the first rotational direction over a second time period that is unequal to the first time period. That is, the wing 14 moves faster forward than backward or vice versa, which generates a net torque on the aerial vehicle 10 about the yaw axis 20.

The wings 14 and the aerial vehicle 10, like many mechanical systems, have a resonant frequency at which forces provided by the actuators 12 are efficiently converted to the angular position Φ of the wings 14. If the control signal 30 oscillates near (e.g., 85-115% of) the resonant frequency, the angular position Φ response is approximately 90 degrees out of phase (behind) the input force produced by the actuators 12. However, the phase response of the component 28 is typically further out of phase compared to the component 26, up to approximately an additional 90 degrees. Therefore, in some examples, the signal generator 18 or the wireless remote control provides the component 28 with a phase lead (e.g., 45-90 degrees or approximately 45 degrees) when compared to the component 26 that is designed to negate the additional high-frequency phase lag. The provided phase lead is generally approximately equal to the phase response difference between the component 26 and the component 28.

FIGS. 6B-D show torques and forces applied to the aerial vehicle 10 based on various control signals 30. FIGS. 6B-D each show the aerial vehicle 10 within a plane defined by the pitch axis 22 and the roll axis 24 (e.g., viewing downward along the yaw axis 20). In FIG. 6B, the wings 14 both flap forward and backward at the same speed in unison, resulting in zero net force or torque except to provide lift thrust along the yaw (vertical) axis. In FIG. 6C, a left wing 14 flaps faster in the forward direction (thicker line) than the backward direction (thinner line), and the right wing 14 flaps out of phase with the left wing, resulting in a counterclockwise torque about the yaw axis on a stroke-averaged basis. In FIG. 6D, forward thrust is generated along the roll axis and the speed differential of the wings 14 is kept in phase, so that both wings 14 actuate a force either in the forward or reverse direction in unison.

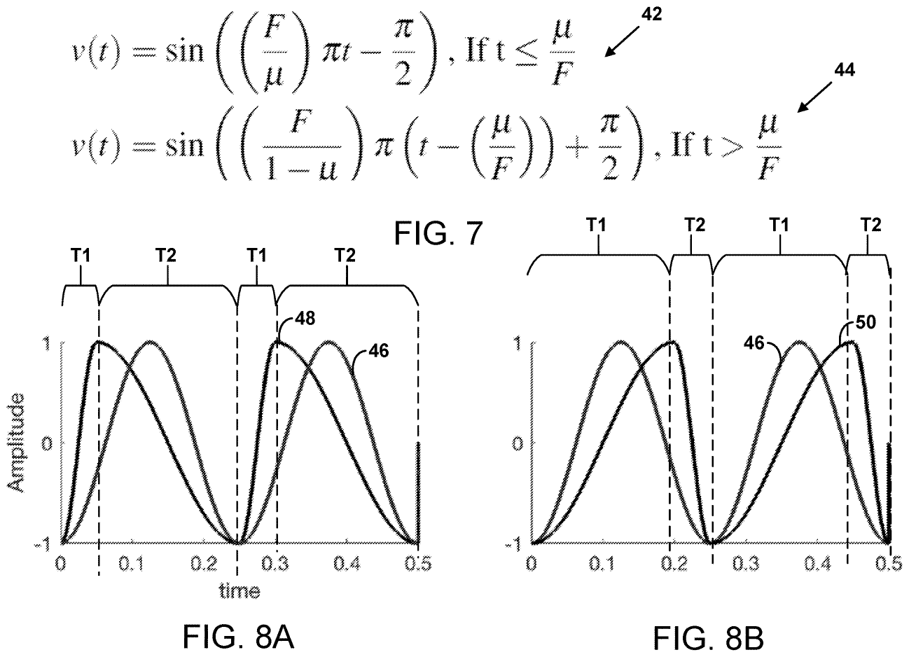

FIG. 7 shows equations that define another example control signal v(t) composed of the fundamental frequency and many harmonics, rather than just one higher harmonic. Rather than decomposing into sinusoid components, it is generally more conveniently defined as in the following. The signal generator 18 or the wireless remote control provides a component 42 of the control signal v(t) to the actuator 12 during a first time period T1 defined by t≤(μ/F). The component 42 has a first oscillation frequency of F/μ. Next, the signal generator 18 or the wireless remote control provides a component 44 of the control signal v(t) to the actuator 12 during a second time period T2 defined by t>(μ/F). The component 44 has a second oscillation frequency of F/(1−μ). As shown, a ratio of the first oscillation frequency F/μ to the second oscillation frequency F/(1−μ), namely (1−μ)/μ, is equal to a ratio of the second time period T2 to the first time period T1. The actuators 12 cause the wings 14 to flap in response to receiving the control signal v(t), thereby causing the aerial vehicle 10 to move in a direction transverse to the yaw axis 20 (e.g., within a plane defined by the pitch axis 22 and the roll axis 24). More specifically, the wings 14 periodically flap in a first rotational direction with respect to the yaw axis 20 and thereafter flap in a second rotational direction that is opposite the first rotational direction with different frequencies.

FIG. 8A and FIG. 8B show examples of the control signal v(t) for varying values of μ. It should be noted that μ is defined differently when pertaining to the control signal v(t) compared to when pertaining to the control signal 30. FIG. 8A shows the control signal v(t) as a curve 46 corresponding to μ=0.5, which results in a conventional symmetric sinusoidal waveform. FIG. 8A also shows the control signal as a curve 48 corresponding to μ=0.2, which results in an asymmetric sinusoid. FIG. 8B also shows the control signal v(t) as the curve 46, as well as the control signal v(t) as the curve 50 corresponding to μ=0.8, which results in an asymmetric sinusoid that has mirror symmetry with the curve 48. The control signal v(t) taking these asymmetric forms defined by the equations of FIG. 7 is what causes the one or more wings 14 to move the aerial vehicle 10 in a direction that is transverse to the yaw axis 20.

The mathematical constraints of the component 42 and the component 44 shown in FIG. 7 result in the component 42 and the component 44 together forming a continuous function. The amplitude of the component 42 is generally equal to the amplitude of the component 44. In some examples, the ratio (1−μ)/μ is greater than or equal to 0.25 and less than or equal to 4.

The control signal v(t) is typically provided to each of two actuators 12 that are positioned on opposite sides of the body 16. More specifically, the signal generator 18 or the wireless remote control provides the component 42 to two actuators 12 in phase and during the first time period T1 and then provides the component 44 to the two actuators 12 in phase and during the second time period T2. This process is generally repeated many times. The resultant flapping of corresponding wings 14 cause the aerial vehicle 10 to move in the direction transverse to the yaw axis 20 (e.g., along the roll axis 24 or along the pitch axis 22), while also providing a thrust that is parallel to the yaw axis 20.

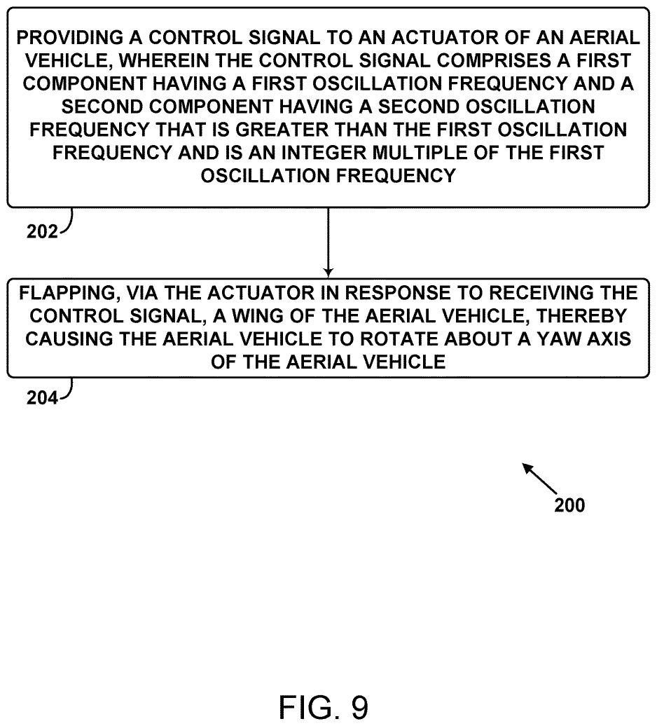

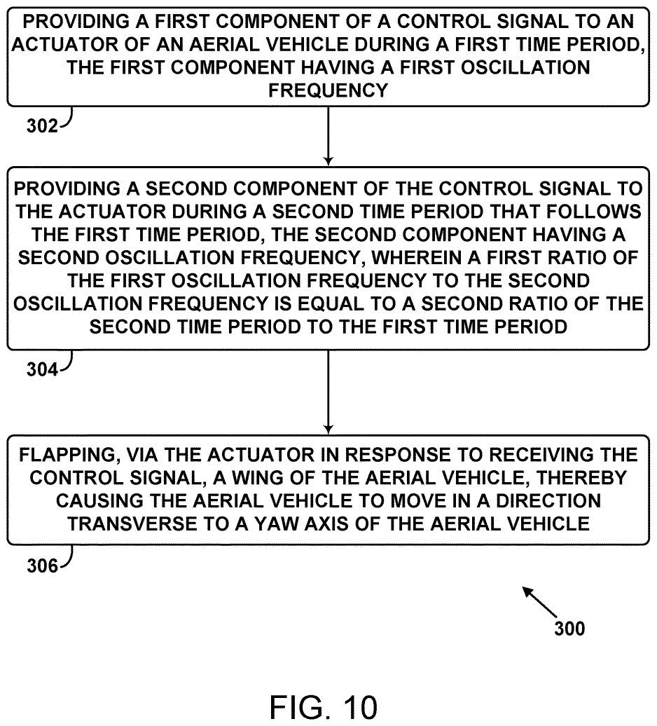

FIG. 9 and FIG. 10 are block diagrams of a method 200 and a method 300 for controlling the aerial vehicle 100. As shown in FIG. 9 and FIG. 10, the method 200 and the method 300 include one or more operations, functions, or actions as illustrated by blocks 202, 204, 302, 304, and 306. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes providing the control signal 30 to the actuator 12 of the aerial vehicle 100. The control signal 30 includes the component 26 having the oscillation frequency f₁ and the component 28 having the oscillation frequency f₂ that is greater than the oscillation frequency f₁ and is an integer multiple of the oscillation frequency f₁. Functionality related to block 202 is described above with reference to FIGS. 2-6.

At block 204, the method 200 includes flapping, via the actuator 12 in response to receiving the control signal 30, the wing 14 of the aerial vehicle 100, thereby causing the aerial vehicle 10 to rotate about the yaw axis 20 of the aerial vehicle 100. Functionality related to block 204 is described above with reference to FIGS. 2-6.

At block 302, the method 300 includes providing the component 42 of the control signal v(t) to the actuator 12 of the aerial vehicle 100 during the first time period T1. The component 42 has the first oscillation frequency F/μ. Functionality related to block 302 is described above with reference to FIGS. 2, 3, 7, and 8.

At block 304, the method 300 includes providing the component 44 of the control signal v(t) to the actuator 12 during the second time period T2 that follows the first time period T1. The component 44 has the second oscillation frequency F/(1−μ). The first ratio (1−μ)/μ of the first oscillation frequency F/μ to the second oscillation frequency F/(1−μ) is equal to the second ratio (1−μ)/μ of the second time period T2 to the first time period T1. Functionality related to block 304 is described above with reference to FIGS. 2, 3, 7, and 8.

At block 306, the method 300 includes flapping, via the actuator 12 in response to receiving the control signal v(t), the wing 14 of the aerial vehicle 100, thereby causing the aerial vehicle 100 to move in a direction transverse to the yaw axis 20 of the aerial vehicle 100. Functionality related to block 306 is described above with reference to FIGS. 2, 3, 7, and 8.

### Further Examples

Unlike conventional drones, insect-sized flapping wing aerial vehicles can move laterally without tilting. This is done by flapping the wings at different speeds in the forward and backward directions to change the net drag force in a flapping cycle. This can help to reject wind disturbances, perform aggressive maneuvers, and allow the aerial vehicle to move without tilting to maintain a sensor or actuator at a specific orientation.

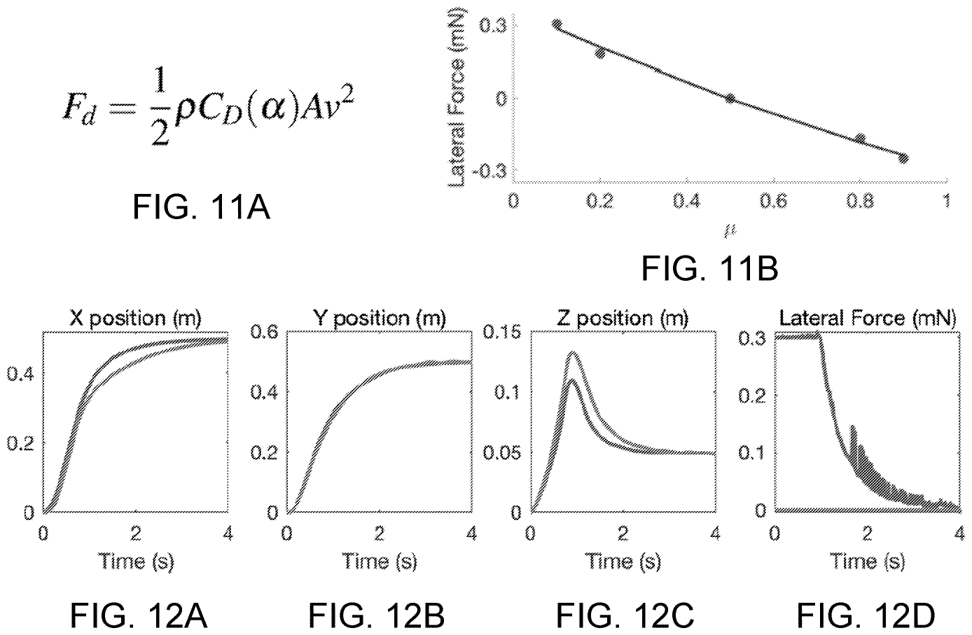

The aerial vehicle uses a sinusoidal signal to generate the flapping motion. This flapping motion generates a lift and a drag force. At the scale of the aerial vehicle, air drag is dominated by the inertial forces. This suggests that the lateral drag force Fa varies quadratically with the relative air speed v, as shown in FIG. 11A.

Here the drag coefficient CD is a function of angle of attack a and A is wing area. If the aerial vehicle flaps its wings at the same speed in upstroke and down stroke, the drag force in each stroke would be equal and opposite and the stroke averaged drag force will be zero. If the wings are flapped faster in upstroke than down stroke, relative airspeed v would be higher in upstroke resulting in a higher drag force in upstroke and net positive stroke averaged drag force. This force is used to move the aerial vehicle laterally.

In a symmetric sinusoidal signal, the first half of the signal takes the same time as the second half of the signal however, in an asymmetric sinusoidal signal, the first half may lead and take less time to complete causing the second half of the signal to lag and take more time to complete or vice-versa. This can be achieved by adding a second harmonic in the signal, but that adds unwanted amplitude to the signal. Instead, two signals with different frequencies are super imposed to generate the desire asymmetric profile, avoiding unnecessary amplitude addition.

In experimental examples, the aerial vehicle is held by a ceramic tweezer that rests on a scale with a balancing mass. This avoids ground effects by ensuring no object is in the aerial vehicle's proximity. FIG. 11B shows that the lateral force varies almost linearly with respect to u with bounds of −0.3 mN to 0.3 mN.

In another experimental example, a receding horizon iterative-LQR technique was introduced to do a controlled hover in simulation. During the maneuver, the aerial vehicle is controlled to get to a position, [0.5, 0.5, 0.05] meters from the origin. The simulation is done on the model of the aerial vehicle learned from the experimental data. The trajectory data of the aerial vehicle is compared with and without lateral force actuation. As expected, FIGS. 12A-D show that with the lateral force actuation the aerial vehicle (light grey) takes about 1.6 s to reach 90% of the desired x position as opposed to 2.3 s without any lateral force (dark grey). This yields about 43% better response in lateral translation. Both the experiments use same Q and R matrices of the controller to have a fair comparison.

The following publication is incorporated by reference: Y. M. Chukewad and S. Fuller, “Yaw Control of a Hovering Flapping-Wing Aerial Vehicle With a Passive Wing Hinge,” in IEEE Robotics and Automation Letters, vol. 6, no. 2, pp. 1864-1871, April 2021, doi: 10.1109/LRA.2021.3060726.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

What is claimed is:

1. A method comprising:
providing a control signal to an actuator of an aerial vehicle, wherein the control signal comprises a first component having a first oscillation frequency and a second component having a second oscillation frequency that is greater than the first oscillation frequency and is an integer multiple of the first oscillation frequency; and
flapping, via the actuator in response to receiving the control signal, a wing of the aerial vehicle, thereby causing the aerial vehicle to rotate about a yaw axis of the aerial vehicle.

2. The method of claim 1, wherein the second oscillation frequency is twice the first oscillation frequency.

3. The method of claim 1, wherein the second component has an amplitude that is 30% or less of an amplitude of the first component.

4. The method of claim 1, wherein the second component is out of phase with the first component.

5. The method of claim 1, wherein the second component is out of phase by 45 to 90 degrees with respect to the first component.

6. The method of claim 1, wherein flapping the wing comprises providing a thrust parallel to the yaw axis.

7. The method of claim 1, wherein the control signal further comprises a third component having a third oscillation frequency that is an integer multiple of the first oscillation frequency and is greater than the second oscillation frequency, the third component being out of phase with the first component and/or the second component.

8. The method of claim 1, wherein flapping the wing comprises periodically moving the wing in a first rotational direction with respect to the yaw axis over a first time period and moving the wing in a second rotational direction that is opposite the first rotational direction over a second time period that is unequal to the first time period.

9. The method of claim 1, wherein flapping the wing comprises the actuator applying a force to the wing within a plane that is normal to the yaw axis.

10. The method of claim 1, wherein the actuator is a first actuator, and the wing is a first wing, the method further comprising:
providing the control signal to a second actuator of the aerial vehicle; and
flapping, via the second actuator in response to receiving the control signal, a second wing of the aerial vehicle, wherein the control signal causes the first wing to apply a first torque about the yaw axis and the control signal causes the second wing to apply a second torque about the yaw axis that is 180 degrees out of phase with the first torque.

11. The method of claim 1, wherein providing the control signal comprises providing the control signal while the aerial vehicle is hovering.

12. A non-transitory computer readable medium storing instructions that, when executed by one or more processors, cause an aerial vehicle to perform functions comprising:
providing a control signal to an actuator of the aerial vehicle, wherein the control signal comprises a first component having a first oscillation frequency and a second component having a second oscillation frequency that is greater than the first oscillation frequency and is an integer multiple of the first oscillation frequency; and
flapping, via the actuator in response to receiving the control signal, a wing of the aerial vehicle, thereby causing the aerial vehicle to rotate about a yaw axis of the aerial vehicle.

13. A method comprising:
providing a first component of a control signal to an actuator of an aerial vehicle during a first time period, the first component having a first oscillation frequency;
providing a second component of the control signal to the actuator during a second time period that follows the first time period, the second component having a second oscillation frequency, wherein a first ratio of the first oscillation frequency to the second oscillation frequency is equal to a second ratio of the second time period to the first time period; and
flapping, via the actuator in response to receiving the control signal, a wing of the aerial vehicle, thereby causing the aerial vehicle to move in a direction transverse to a yaw axis of the aerial vehicle.

14. The method of claim 13, wherein providing the second component comprises providing the second component such that the first component and the second component form a continuous function.

15. The method of claim 13, wherein the first ratio and the second ratio are greater than or equal to 0.25 and less than or equal to 4.

16. The method of claim 13, wherein the actuator is a first actuator, and the wing is a first wing, the method further comprising:
providing the first component to a second actuator of the aerial vehicle during the first time period;
providing the second component to the second actuator during the second time period; and
flapping, via the second actuator in response to receiving the control signal, a second wing of the aerial vehicle, thereby causing the aerial vehicle to move in the direction transverse to the yaw axis.

17. The method of claim 13, wherein providing the second component comprises providing the second component such that the second component has an amplitude that is equal to an amplitude of the first component.

18. The method of claim 13, wherein flapping the wing comprises providing a thrust parallel to the yaw axis.

19. The method of claim 13, wherein flapping the wing comprises periodically moving the wing in a first rotational direction with respect to the yaw axis and thereafter moving the wing in a second rotational direction that is opposite the first rotational direction.

20. The method of claim 13, wherein flapping the wing comprises the actuator applying a force to the wing within a plane that is normal to the yaw axis.
